(19) United States
(12) Patent Application Publication
(10) Pub. No.: US 2026/0196181 A1
(43) Pub. Date: Jul. 9, 2026

(54) SELF-LUMINOUS DISPLAY DEVICE

(71) Applicant: Sharp Display Technology Corporation, Kameyama City, Mie (JP)

(72) Inventor: MAKOTO SHIOMI, Sakai City, Osaka (JP)

(21) Appl. No.: 19/128,147

(22) PCT Filed: Nov. 17, 2022
(86) PCT No.: PCT/JP2022/042653

§ 371 Date: May 7, 2025

(51) Int. Cl. G09G 3/34

(52) U.S. Cl. CPC G09G 3/3406; G09G 2320/066; G09G 2320/0673

(57) ABSTRACT

A self-luminous display device includes a display surface, first pixels, second pixels, and dimming units. Outgoing light from the first pixels emitting light at a maximum luminance is first light. Outgoing light from the second pixels emitting light at a maximum luminance is second light. A ratio of difference between an intensity of the first light exited from the first pixels and an intensity of the first light exited outside from the display surface, to the intensity of the first light exited from the first pixels is a first dimming ratio, a ratio of difference between an intensity of the second light exited from the second pixels and an intensity of the second light exited outside from the display surface, to the intensity of the second light exited from the second pixels is a second dimming ratio, and the second dimming ratio is larger than the first dimming ratio.

### TECHNICAL FIELD

One aspect of the present disclosure relates to a self-luminous display device.

### BACKGROUND ART

Various proposals have been made in relation to self-luminous display devices, which are display devices including self-emission elements as light sources. For example, Patent Literature 1 discloses a technique for improving the visibility of a composite display device in which a transparent electro-luminescence (EL) display is disposed on the front surface of the display device.

### CITATION LIST

### Patent Literature

Patent Literature 1: Japanese Unexamined Patent Application Publication No. 10-91076

### SUMMARY

### Technical Problem

It is desired to improve display performance in a low-luminance region.

### Solution to Problem

A self-luminous display device according to one aspect of the present disclosure includes the following: a display surface; first pixels each including one or more first subpixels; second pixels each including one or more second subpixels; and dimming units configured to prevent a part of light exited from the second pixels from passing through the display surface. In a plan view from the direction of the normal to the display surface, one of the second pixels is positioned so as to correspond to one or more of the first pixels. Outgoing light from the first pixels emitting light at a maximum luminance is first light. Outgoing light from the second pixels emitting light at a maximum luminance is second light. The ratio of difference between the intensity of the first light exited from the first pixels and the intensity of the first light exited outside from the display surface, to the intensity of the first light exited from the first pixels is a first dimming ratio. The ratio of difference between the intensity of the second light exited from the second pixels and the intensity of the second light exited outside from the display surface, to the intensity of the second light exited from the second pixels is a second dimming ratio. The second dimming ratio is larger than the first dimming ratio.

### Advantageous Effect of Disclosure

The aspect of the present disclosure can improve display performance in a low-luminance region.

### BRIEF DESCRIPTION OF DRAWINGS

FIG. 1 shows emission-luminance response waveforms of light of various luminance levels emitted from a known display device.

FIG. 2 shows an example spatial-division gradation expression in the known display device.

FIG. 3 is a table showing example correspondences between the gradation levels 1 to 16 in a 256-level gradation expression (0 to 255 gradation levels), luminance, and contrast, in a self-luminous element whose gamma setting stands at 2.2.

FIG. 4 shows an example temporal-division gradation expression in the known display device.

FIG. 5 is a block diagram schematically illustrating the configuration of a display device according to a first embodiment.

FIG. 6 is a schematic front view of a layer structure in the display device according to the first embodiment.

FIG. 7 is a schematic plan view of the display device according to the first embodiment, with illustration of the positional relationship between its individual pixels.

FIG. 8 is a table showing example correspondences between the gradation level of first pixels, luminance, and the gradation level of a second pixel, in a 256-level gradation expression.

FIG. 9 is a graph showing the relationship between the gradation level of the first pixels and luminance in example display control based on a luminance threshold setting in the first embodiment.

FIG. 10 is a schematic plan view of a display device according to a second embodiment, with illustration of an example positional relationship between its individual pixels.

FIG. 11 is a schematic plan view of the display device according to the second embodiment, with illustration of another example positional relationship between its individual pixels.

FIG. 12 is a schematic plan view of the display device according to the second embodiment, with illustration of further another example positional relationship between its individual pixels.

FIG. 13 is table showing a second dimming ratio necessary for various combinations of an area ratio and a number ratio in a first example.

FIG. 14 is a table showing the second dimming ratio necessary for various combinations of an area ratio and a number ratio in a second example.

FIG. 15 is a table showing the second dimming ratio necessary for various combinations of an area ratio and a number ratio in a third example.

FIG. 16 is a table showing luminance corresponding to each of the gradation levels 1 to 32 of first pixels in a 256-level gradation expression.

FIG. 17 is a table showing the second dimming ratio necessary for various combinations of a lower-limit gradation level of the first pixels and an area ratio in the case of a number ratio of 1.

FIG. 18 is a schematic plan view of an example configuration of dimming units included in a display device according to a third embodiment.

FIG. 19 is a schematic front view of the example configuration of the dimming units included in the display device according to the third embodiment.

FIG. 20 is a schematic front view of a first modification of the dimming units.

FIG. 21 is a schematic front view of a second modification of the dimming unit.

FIG. 22 is a schematic front view of a third modification of the dimming units.

FIG. 23 is a schematic front view of the configuration of a display device according to a fourth embodiment.

FIG. 24 is a schematic plan view of the configuration of a display device according to a fifth embodiment.

FIG. 25 is a schematic plan view of the configuration in a modification of the display device according to the fifth embodiment.

### DESCRIPTION OF EMBODIMENTS

### Reference Embodiment

A reference embodiment will be described prior to a first embodiment. For the sake of simplicity, descriptions of known arts will be omitted as appropriate. Each component (constituent) and each numerical value that will be described in the Description are mere examples unless otherwise inconsistent. Thus, for example, unless otherwise inconsistent, the positional relationship and connection relationship between the individual components are not limited to the examples illustrated in the drawings. Further, the drawings are not necessarily drawn to scale. In the Description, a self-luminous display device will be abbreviated as a “display device” unless otherwise inconsistent.

### Example Luminance Control in Known Display Device

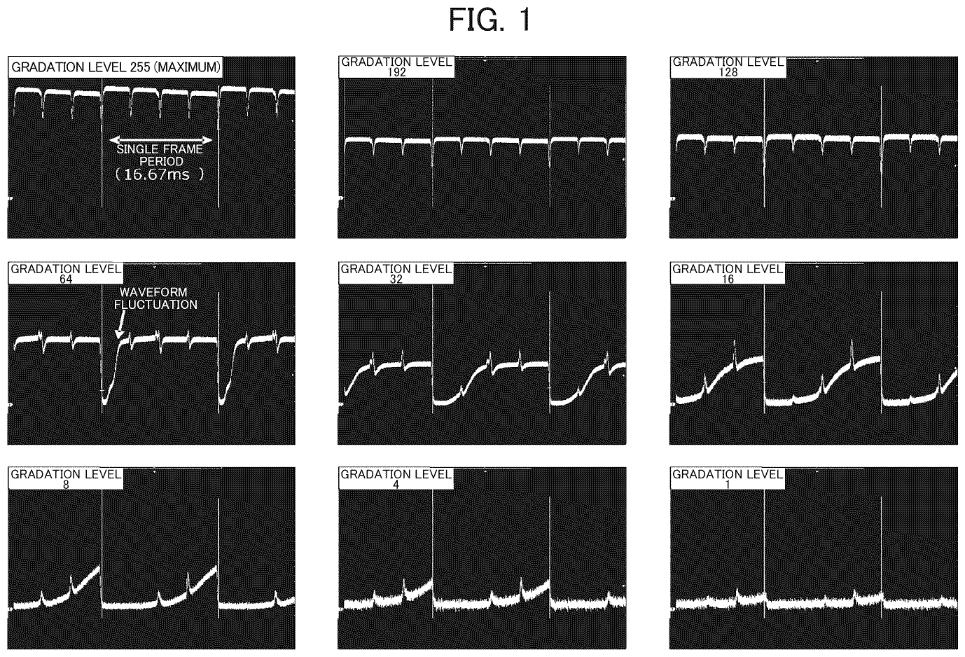

Example luminance control in a known display device will be described with reference to FIG. 1. FIG. 1 shows emission-luminance response waveforms of light of various luminance levels emitted from the display device. The self-luminous element in the example of FIG. 1, which is a light source of the display device, is an organic light-emitting diode (OLED). However, as will be apparent to those skilled in the art, the self-luminous element according to one aspect of the present disclosure may be a quantum dot LED (QLED). The self-luminous element according to one aspect of the present disclosure may be a charge-injection self-luminous element.

In each graph in FIG. 1, the horizontal axis represents time, and the vertical axis represents luminance corresponding to voltage applied to the self-luminous element. In the example in FIG. 1, the display device is driven by applying four pulses to the self-luminous element during a single frame period. That is, in the example in FIG. 1, a single frame period is divided into four subframe periods, and a single pulse is applied during a single subframe period. The frame rate in the example in FIG. 1 is 60 Hz. Thus, a single frame period in the example in FIG. 1 is 16.67 ms (millisecond). The foregoing technique, which is driving a self-luminous element by dividing a single frame period into a plurality of subframe periods, is one known technique that has been used to stabilize the amount of charge injection into the self-luminous element.

FIG. 1 illustrates example luminance control by 256-level gradation expression ranging from the gradation levels 0 to 255. The self-luminous element emits light at the maximum luminance when driven at the gradation level 255. The self-luminous element in contrast emits light at the minimum luminance when driven at the gradation level 1.

As shown in FIG. 1, when the luminance of the self-luminous element is high (e.g., the gradation level 128 or higher), there is few fluctuations in the waveform of the luminance corresponding to a voltage. This reveals that the self-luminous element operates properly at a high luminance level (e.g., the gradation level 128 or higher).

However, when the luminance of the self-luminous element is lowered to a certain extent, the waveform starts to fluctuate. In the example in FIG. 1, a waveform fluctuation during frame switching is observed at the gradation level 64. The luminance of the self-luminous element at the gradation level 64 is about 5% of the foregoing maximum luminance.

Moreover, the waveform fluctuation becomes more prominent as the luminance of the self-luminous element becomes lower. This reveals that the self-luminous element highly possibly no longer operates properly at a low luminance level. Such a behavior of the self-emitting element is caused by decrease in the amount of charge injection into the self-luminous element along with decrease in the luminance of the self-luminous element. Thus, the tendency shown in FIG. 1 is observed in not only an OLED, but also other types of charge-injection self-luminous elements. As described above, the known display device can degrade display performance in a low-luminance region. Contrivances to improve display performance in a low-luminance region are hence required.

### Example Spatial-Division Gradation Expression in Known Display Device

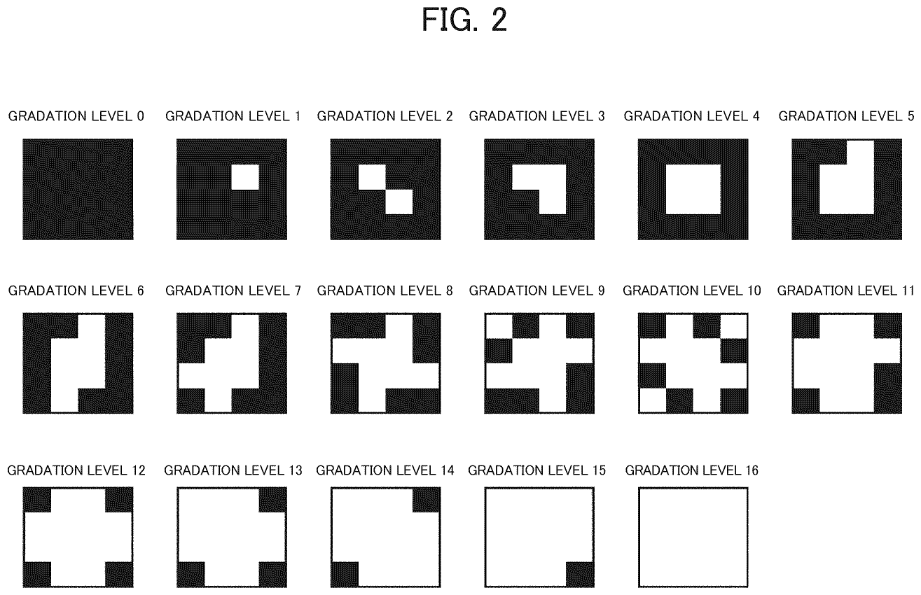

FIG. 2 shows an example spatial-division gradation expression in the known display device. FIG. 2 illustrates a 17-level gradation expression ranging from the gradation levels 0 to 16 through spatial-division gradation expression. In the example in FIG. 2, a single dither pattern is formed by, for example, 16 pixels. Specifically, a single dither pattern is formed by arranging four pixels per line in each of the horizontal direction (lateral direction) and vertical direction (longitudinal direction) on the display surface of the display device. The pixels within the dither pattern are either white pixels (pixels of maximum luminance) or black pixels (pixels of zero luminance).

Accordingly, increasing the number of white pixels within the dither pattern one by one provides a 17-level gradation expression, as shown in FIG. 2. The dither pattern at the gradation level 0 in the example in FIG. 2 includes only black pixels. On the other hand, the dither pattern at the gradation level 16 includes only white pixels.

Spatial-division gradation expression is an example technique for improving display performance in a low-luminance region. However, luminance in spatial-division gradation expression is limited to luminance in which the luminance of a single white pixel within a dither pattern is linearly interpolated. Spatial-division gradation expression is thus insufficient to improve display performance in a low-luminance region.

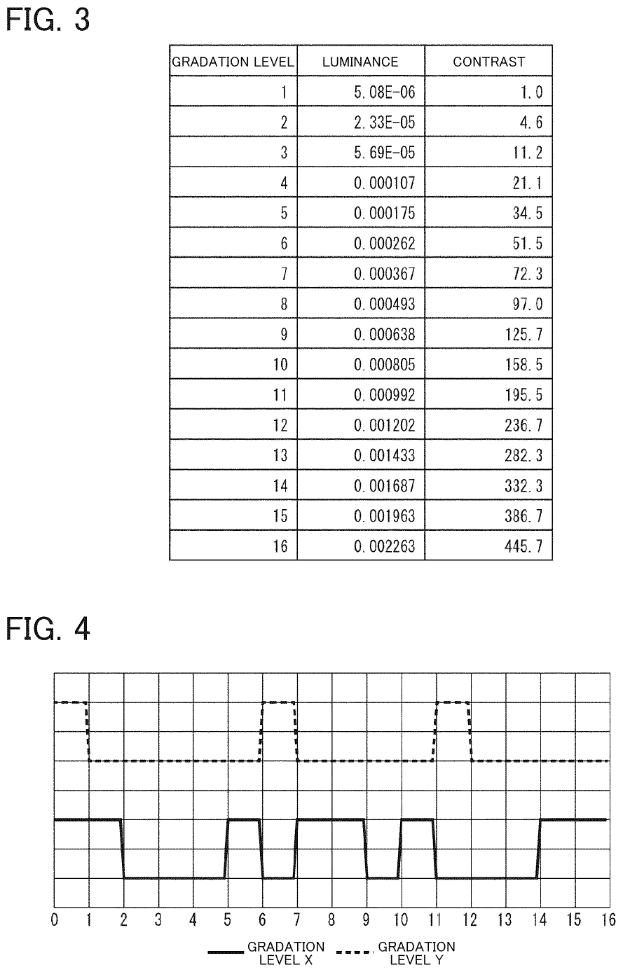

Further, spatial-division gradation expression needs to increase the dither pattern's area in order to achieve a more precise gradation expression. FIG. 3 is a table showing example correspondences between the gradation levels 1 to 16 in a 256-level gradation expression (0 to 255 gradation levels), luminance, and contrast, in a self-luminous element whose gamma setting stands at 2.2. The luminance in the example in FIG. 3 is normalized such that the luminance corresponding to the gradation level 255 stands at 1. As can be seen from FIG. 3, the luminance at the gradation level 16 in the 256-level gradation expression exceeds 400 times the luminance at the gradation level 1.

Accordingly, a single dither pattern needs to be formed by more than 400 pixels in order to express the gradation levels 1 to 16 among the 265 gradation levels through spatial-division gradation expression. As such, a dither pattern having a large area is visually recognized easily by a user (viewer) during video (or image) display. This can degrade display quality.

### Example Temporal-Division Gradation Expression in Known Display Device

FIG. 4 shows an example temporal-division gradation expression in the known display device. FIG. 4 illustrates a 17-level gradation expression ranging from the gradation levels 0 to 16 through temporal-division gradation expression. In spatial-division gradation expression, a single frame period is divided into 16 subframe periods for instance. Each subframe period is assigned a High value (corresponding to maximum luminance) or a Low value (corresponding to zero luminance) of a pulse.

Increasing the number of subframe periods to be assigned the High value one by one provides a 17-level gradation expression. The pulse pattern of the gradation level X in FIG. 4 is an example pulse pattern for expressing the gradation level 8. Further, the pulse pattern of the gradation level Y in FIG. 4 is an example pulse pattern for expressing the gradation level 3.

Temporal-division gradation expression is another example technique for improving display performance in a low-luminance region. However, luminance in temporal-division gradation expression is limited to luminance in which the maximum luminance in a single subframe period is linearly interpolated. Temporal-division gradation expression is thus insufficient to improve display performance in a low-luminance region.

Further, temporal-division gradation expression needs to increase the number of subframe periods in order to achieve a more precise gradation expression. For instance, a single frame period needs to be divided into more than 400 subframe periods in order to express the gradation levels 1 to 16 among the 265 gradation levels through temporal-division gradation expression. However, as will be apparent to those skilled in the art, accurately driving the display device becomes more difficult along with increase in the number of subframe periods. Accordingly, it is difficult to sufficiently improve display performance in a low-luminance region through temporal-division gradation expression.

### First Embodiment

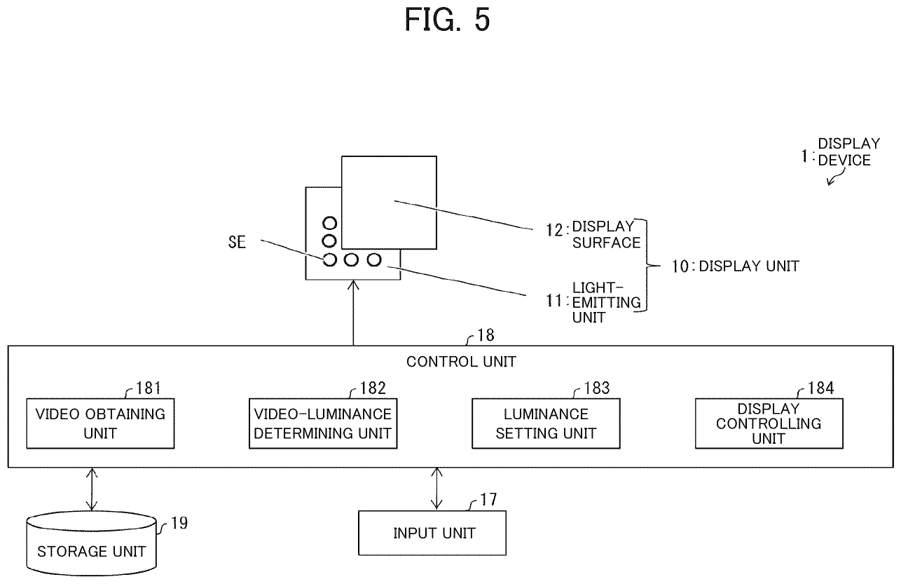

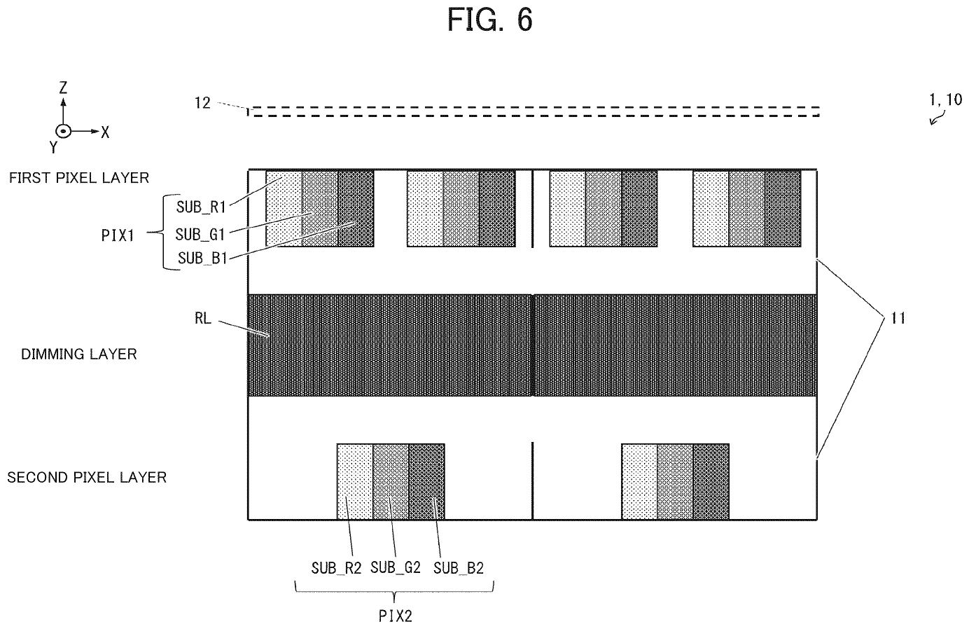

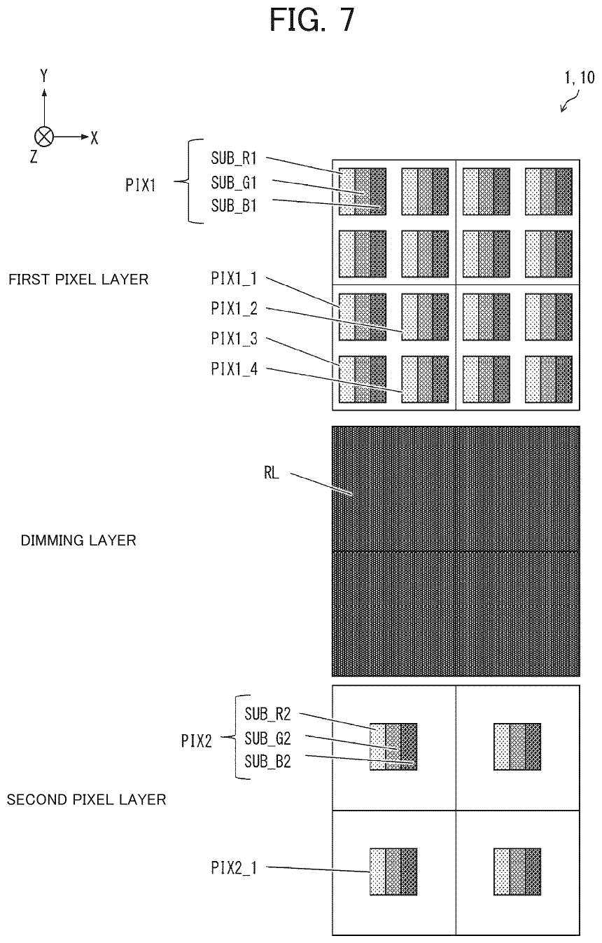

The inventor of the present application has newly created a display device 1 according to the first embodiment in view of the above-described problems in the known display device. The configuration of the display device 1 will be described with reference to FIGS. 5 to 7. FIG. 5 is a block diagram schematically illustrating the configuration of the display device 1. FIG. 6 is a schematic front view of a layer structure in the display device 1. FIG. 7 is a schematic plan view of the display device 1, with illustration of the positional relationship between its individual pixels.

As illustrated in FIG. 5, the display device 1 includes a display unit 10, an input unit 17, a control unit 18, and a storage unit 19. The display unit 10 includes a light-emitting unit 11 and a display surface 12. The display surface 12 is positioned so as to overlap the light-emitting unit 11. The display surface 12 is positioned above (which will be described later on) the light-emitting unit 11. The light-emitting unit 11 includes a plurality of self-luminous elements SE as subpixels, which will be described later on. The display unit 10 is thus also referred to as a self-luminous panel. Each pixel layer that will be described later on is an example of the light-emitting unit 11.

The input unit 17 receives an input operation from a user of the display device 1. The control unit 18 controls the individual units of the display device 1 in an integrated manner. The storage unit 19 stores various kinds of data and programs that are used for the processing in the control unit 18.

The control unit 18 may include a video obtaining unit 181, a video-luminance determining unit 182, a luminance setting unit 183, and a display controlling unit 184. The control unit 18 (more specifically, the display controlling unit 184) may control the emission states of the self-luminous elements SE. The control unit 18 may thus control the emission state of first pixels PIX1 and the emission state of second pixels PIX2, both of which will be described below.

Reference is now made to FIG. 6. For convenience in description, the Description uses an X-Y-Z orthogonal coordinate system illustrated in FIG. 6. The Z-direction in the Description represents the direction of the normal to the display surface 12. The Z-direction can be also expressed as the thickness direction of each layer of the display unit 10. The positive Z-direction in the Description is directed from a substrate not shown supporting each unit of the display unit 10, toward the display surface 12. Thus, the side in the positive Z-direction may be also referred to as a display-surface side (or a viewer side). The side in the negative Z-direction may be also referred to as a substrate side. In the Description, the positive and negative Z-directions will be also referred to as top and bottom, respectively.

The X- and Y-directions in FIG. 6 are each directions orthogonal to the Z-direction. The Y-direction is an example direction intersecting with the X-direction in plan view from the Z-direction (hereinafter, simply referred to as “plan view”). For instance, the X- and Y-directions may be respectively the horizontal direction (lateral direction) and vertical direction (longitudinal direction) of the display surface 12. In the Description, the X-direction and the Y-direction will be also referred to as a first direction and a second direction, respectively.

As illustrated in FIG. 6, the light-emitting unit 11 of the display unit 10 includes first pixels PIX1 and second pixels PIX2. The display unit 10 also includes dimming units RL. In the Description, a layer including the first pixels PIX1 and a layer including the second pixels PIX2 will be referred to as a first pixel layer and a second pixel layer, respectively. Further, a layer including the dimming units RL will be referred to as a dimming layer. FIG. 6 illustrates an example where the second pixel layer, the dimming layer, and the first pixel layer are positioned in the stated order from bottom to top.

Each of the first pixels PIX1 and second pixels PIX2 may include one or more subpixels. In the Description, a subpixel constituting the first pixel PIX1 will be referred to as a first subpixel. On the other hand, a subpixel constituting the second pixel PIX2 will be referred to as as a second subpixel.

The first embodiment will describe, by way of example, an instance where the display unit 10 is a multicolor panel. To be more specific, the first embodiment will describe, by way of example, an instance where the display unit 10 is an RGB (i.e., red, green, and blue) panel. As such, a single first pixel PIX1 may include, as illustrated in FIG. 6, a single red first subpixel SUB_R1 (e.g., red light-emitting unit), a single green first subpixel SUB_G1 (e.g., green light-emitting unit), and a single blue first subpixel SUB_B1 (e.g., blue light-emitting unit). Likewise, a single second pixel PIX2 may include a single red second subpixel SUB_R2, a single green second subpixel SUB_G2, and a single blue second subpixel SUB_B2.

FIG. 6 illustrates an example where the first pixels PIX1 are positioned above the second pixels PIX2. The dimming units RL can prevent a part of light exited from the second pixels PIX2 from passing through the display surface. FIG. 6 illustrates an example where the dimming units RL are positioned over the second pixels PIX2 and thus cover the second pixels PIX2. As will be described later on, the dimming units RL may be light-absorptive units that absorb light. Alternatively, the dimming units RL may be light-reflective units that reflect light. The display device according to one aspect of the present disclosure may be structured such that a single dimming unit covers one or more second pixels PIX2.

The dimming units RL in the example in FIG. 6 are positioned under the first pixels PIX1 and thus do not cover the first pixels PIX1. The dimming units RL cannot thus prevent a part of light exited from the first pixels PIX1 from passing through the display surface. As such, in the display unit 10, the dimming ratio (second dimming ratio) of the second pixels PIX2 is larger than the dimming ratio (first dimming ratio) of the first pixels PIX1.

In the Description, outgoing light from the first pixels PIX1 emitting light at the maximum luminance will be referred to as first light. Moreover, the intensity of the first light exited from the first pixels PIX1 will be denoted as I1. Further, the intensity of the first light exited outside from the display surface 12 will be denoted as I1′. Furthermore, the difference between I1 and I1′ will be denoted as All. Here, ΔI1=I1−I1′ is established.

The first dimming ratio (denoted as Ratio1 for convenience) in the Description is defined as the ratio of ΔI1 to I1. That is, Ratio1 is expressed as

$$Ratio 1 = Δ I 1 / I 1 = ( I 1 - I 1 ’ ) / I 1. \qquad ( 1 )$$

By way of example, the fact that Ratio1 standing at 0.1 (i.e., 10%) means that 10% of the total amount of the first light does not exit outside. In other words, the fact that Ratio1 stands at 0.1 means that 90% of the total amount of the first light exits outside.

In the Description, outgoing light from the second pixels PIX2 emitting light at the maximum luminance will be referred to as second light. Moreover, the intensity of the second light exited from the second pixel PIX2 will be denoted as I2. In addition, the intensity of the second light exited outside from the display surface 12 will be denoted as I2′. Furthermore, the difference between I2 and I2′ will be denoted as ΔI2. Here, ΔI2=I2−I2′ is established.

The second dimming ratio (denoted as Ratio2 for convenience) in the Description is defined as the ratio of ΔI2 to I2. That is, Ratio2 is expressed as

$$Ratio 2 = Δ I 2 / I 2 = ( I 2 - I 2 ’ ) / I 2. \qquad ( 2 )$$

By way of example, the fact that Ratio2 standing at 0.9 (i.e., 90%) means that 90% of the total amount of the second light does not exit outside. In other words, the fact that Ratio2 stands at 0.9 means that 10% of the total amount of the second light exits outside.

Ideally, each of the above-mentioned dimming ratios is constant in the entire wavelength range of visible light. However, it is sufficient that each of the dimming ratios is substantially constant in the main wavelength range in the spectrum of light emitted from the self-luminous elements SE. The main wavelength range can vary in accordance with the specifications of the self-luminous elements SE. By way of example, it is sufficient that each of the dimming ratios in the first embodiment is substantially constant near a 450 nm wavelength (a wavelength range corresponding to blue light), near a 550 nm wavelength (a wavelength range corresponding to green light), and a 650 nm wavelength (a wavelength range corresponding to red light).

Reference is now made to FIG. 7. FIG. 7 is a plan view of the first pixel layer, dimming layer, and second pixel layer. The display device according to one aspect of the present disclosure may be structured such that a single second pixel PIX2 is positioned so as to correspond to one or more first pixels PIX1 in plan view. The first embodiment illustrates an instance where a single second pixel PIX2 is positioned so as to correspond to a plurality of first pixels PIX1 in plan view.

FIG. 7 illustrates an example where in plan view, a single second pixel PIX2 (e.g., a second pixel PIX2_1) corresponds to a single first-pixel group including four first pixels PIX1 (e.g., first pixels PIX1_1 to PIX1_4). In the single first-pixel group in the example in FIG. 7, (i) two first pixels PIX1 are positioned per line in the X-direction, and (ii) two first pixels PIX1 are positioned per line in the Y-direction.

Further, in plan view, a single second pixel PIX2 may be positioned at the center of the plurality of first pixels PIX1 corresponding to the single second pixel PIX2. For instance, a single second pixel PIX2_1 may be positioned at the center of four first pixels PIX1_1 to PIX1_4, as illustrated in FIG. 7.

The expression “a single second pixel PIX2 is positioned so as to correspond to plurality of first pixels PIX1 in plan view” in the Description means that there is a plurality of first pixels PIX1 whose closest second pixel PIX2 in plan view is the single second pixel PIX2. The distance in this definition may be, for example, the distance between the center of the first pixels PIX1 and the center of the second pixel PIX2 in plan view.

The details will be described below with reference to FIG. 7. First, attention is paid to each of the first pixels PIX1_1 to PIX1_4. The second pixel PIX2 that is the closest to the first pixel PIX1_1 in plan view is the second pixel PIX2_1. Likewise, the second pixel PIX2 that is the closest to the first pixel PIX1_2 is the second pixel PIX2_1. The second pixel PIX2 that is the closest to the first pixel PIX1_3 is the second pixel PIX2_1. The second pixel PIX2 that is the closest to the first pixel PIX1_4 is the second pixel PIX2_1. Next, attention is paid to the second pixel PIX2_1. The first pixels PIX1 whose closest second pixel PIX2 in plan view is the second pixel PIX2_1 are the first pixels PIX1_1, PIX1_2, PIX1_3, and PIX1_4.

Further, the expression “a single second pixel PIX2 is positioned so as to correspond to a single first pixel PIX1 in plan view” in the Description means that there is only a single first pixel PIX1 whose closest second pixel PIX2 in plan view is the single second pixel PIX2. The expression “a single second pixel PIX2 is positioned so as to correspond to one or more first pixels PIX1 in plan view” thus means that there are one or more first pixels PIX1 whose closest second pixel PIX2 in plan view is the single second pixel PIX2 when attention is paid to a certain second pixel PIX2.

As can be understood from the foregoing descriptions, the second pixels PIX2 in the display unit 10 are more suitable for display in a low-luminance region than the first pixels PIX1. Accordingly, by way of example, upon the luminance of the first pixels PIX1 falling below a luminance threshold, the control unit 18 may turn off the first pixels PIX1 and turn on the second pixels PIX2; here the first pixels PIX1 correspond to the second pixels PIX2.

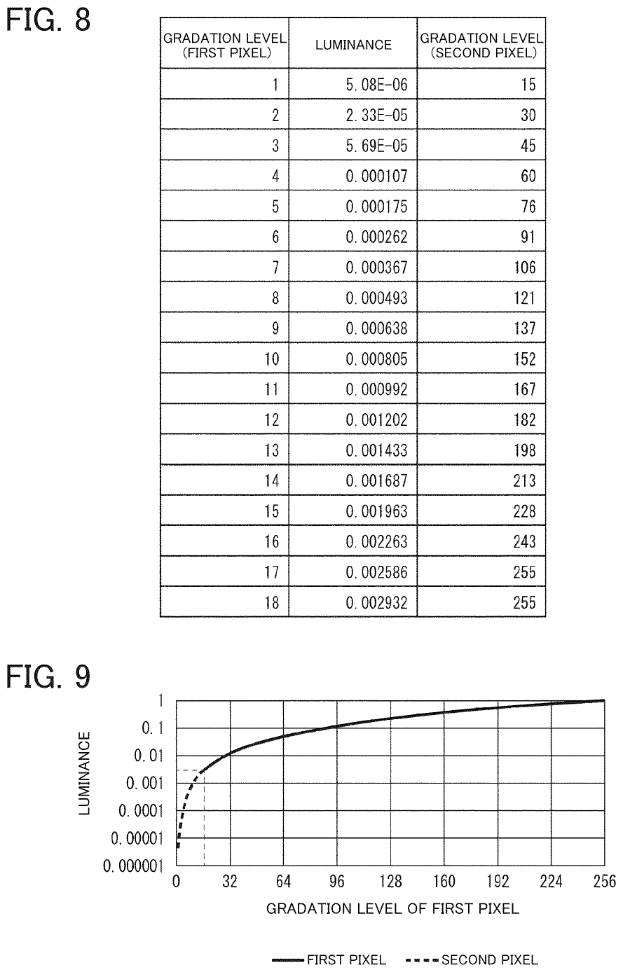

FIG. 8 is a table showing example correspondences between the gradation level of the first pixels PIX1, luminance, and the gradation level of the second pixels PIX2, in a 256-level gradation expression. The luminance in FIG. 8 is a normalized value based on a self-luminous element whose gamma setting stands at 2.2, and whose luminance stands at 1 when the first pixels PIX1 are at the gradation level 255. Further, the gradation level of the second pixels PIX2 in FIG. 8 are each a calculated value in the configuration illustrated in FIGS. 6 and 7, where four first pixels PIX1 correspond to a single second pixel PIX2, and in the case where the second dimming ratio stands at 99%.

As earlier described, Rato2 is larger than Ratio1 in the display device 1. Thus, in the display device 1, the gradation level of the second pixels PIX2 corresponding to a certain luminance is larger than the gradation level of the first pixels PIX1 corresponding to the certain luminance, as shown in FIG. 8. In the example in FIG. 8, the gradation level 1 of the first pixels PIX1 corresponds to the gradation level 15 of the second pixels PIX2. Moreover, increasing the gradation level of the first pixels PIX1 by only one substantially corresponds to increasing the gradation level of the second pixels PIX2 by fifteen.

In the example in FIG. 8, the gradation level of the second pixels PIX2 is saturated in luminance regions corresponding to the gradation level 17 and higher levels of the first pixels PIX1. As such, the second pixels PIX2 can be regarded as being suitable for display in luminance regions corresponding to the gradation level 16 and lower levels of the first pixels PIX1.

The luminance regions corresponding to the gradation level 16 and lower levels of the first pixels PIX1 in the example in FIG. 8 is examples of the foregoing low-luminance region. In the Description, a region excluding a low-luminance region among the luminance regions in a certain gradation expression will be referred to as a non-low-luminance region. The luminance regions corresponding to the gradation level 17 and higher levels of the first pixels PIX1 in the example in FIG. 8 are example non-low-luminance regions.

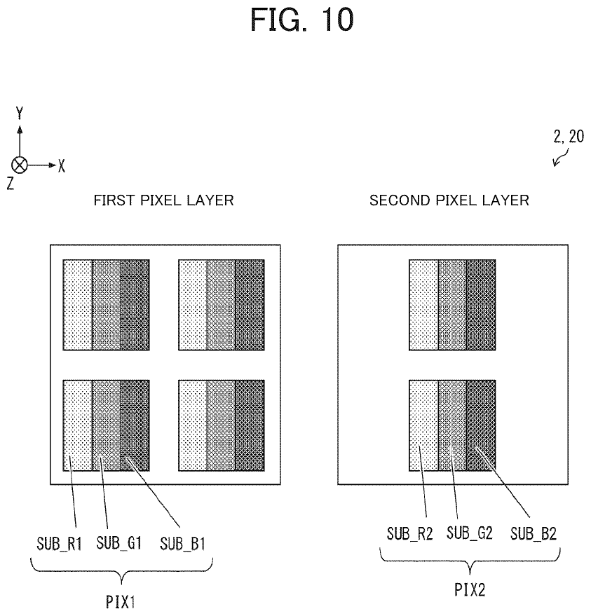

The luminance threshold may be set as a luminance value for distinguishing a low-luminance region from a non-low-luminance region. The luminance threshold may be set at 0.0025 for instance (see a second embodiment, which will be described later on). FIG. 9 is a graph showing the relationship between the gradation level of the first pixels PIX1 and luminance in example display control based on this luminance threshold setting. In the graph, the horizontal axis represents the gradation level of the first pixels PIX1, and the vertical axis represents the luminance.

Based on the foregoing luminance threshold, the luminance regions corresponding to the gradation level 16 and lower levels of the first pixels PIX1 are set as low-luminance regions. As shown in FIG. 9, the control unit 18 may control only the second pixels PIX2 to emit light in a low luminance region. As such, the display device 1 enables display in a low-luminance region by using only the second pixels PIX2.

On the other hand, based on the foregoing luminance threshold, the luminance regions corresponding to the gradation level 17 and higher levels of the first pixels PIX1 are set as non-low-luminance regions. As shown in FIG. 9, the control unit 18 may control only the first pixels PIX1 to be turned on in a non-low-luminance region. As such, the display device 1 enables display in a non-low-luminance region by using only the first pixels PIX1.

As described above, the display device 1 can display a low-luminance region without driving the first pixels PIX1 at a low gradation level. To be specific, the display device 1 can display a low-luminance region by driving the second pixels PIX2 at a relatively high gradation level. The display device 1 can consequently drive the self-luminous elements SE so as to reduce the possibility that the self-luminous elements SE operate improperly, and can display a low-luminance region.

As such, the display device 1 can improve display performance in a low-luminance region when compared with known display devices. The recent high dynamic range (HDR) technique requires improvements of display performance in a low-luminance region. The display device 1 is thus suitable in the HDR field. For instance, the display device 1 achieves high-resolution display with high display quality.

Supplement to FIG. 9 Let the luminance in the example in FIG. 9 be denoted as L, and let the gradation level of the first pixels PIX1 in the same be denoted as PG1; accordingly, L can be expressed as

$$L = ( PG 1 / 255 ) \hat{} γ . \qquad ( 3 )$$

The symbol “\hat{ }” represents a power. In addition, γ is a correction value in the first pixels PIX1, and hereinafter, it will be referred to as a “gamma value”. In the example according to the first embodiment, γ is equal to 2.2. This gamma value is actually used in many display devices.

As will be apparent to those skilled in the art, the gamma value according to one aspect of the present disclosure may be set at any value. Accordingly, the gamma value is not limited to 2.2. When a display device having a gamma setting other than a gamma value of 2.2 is used in the configuration according to each embodiment, the gradation level is corrected by the use of a gamma value corresponding to the gamma setting. A gamma setting with a gamma value of 1.8 to 2.6 has been widely used in commercial display devices.

Moreover, let the gradation level of the second pixel PIX2 in the example in FIG. 9 be denoted as PG2; accordingly, PG can be expressed as

$$PG 2 = \{ ( L / α ) \hat{} ( 1 / γ ) \} \times 255. \qquad ( 4 )$$

Here, α is a coefficient that is set in view of the area of the second pixel PIX2 and the foregoing second dimming ratio. In the example according to the first embodiment, α is equal to 0.0025.

The term “\hat{ }(1/γ)” in Equation (4) represents a reverse gamma conversion. In the setting according to first embodiment, the gamma value in the second pixels PIX2 is equal to the gamma value in the first pixels PIX1. In the example according to the first embodiment, PG2 calculated through Equation (4) is clipped so that the maximum value stands at 255.

As will be apparent to those skilled in the art, different gamma values may be set between the first pixel PIX1 and the second pixel PIX2. However, a common gamma value is preferably set in the first pixel PIX1 and the second pixel PIX2. This is because that doing so facilitates driving the first pixels PIX1 and second pixels PIX2 by the use of a common driver circuit. Further, setting the gamma values of the first pixel PIX1 and second pixel PIX2 at the same value can commonize display properties between during the display in a low-luminance region and during the display in a non-low-luminance region.

Example Video Display Processing in Display Device 1 The following describes the example configuration shown in FIGS. 6 and 7, in which four first pixels PIX1 correspond to a single second pixel PIX2. First, the video obtaining unit 181 obtains video data (a display signal indicating a video) stored in the storage unit 19. It is noted that the video data and the first pixels PIX1 have the same number of pixels. Moreover, the video obtaining unit 181 supplies the video data to the video-luminance determining unit 182. For instance, a predetermined luminance threshold may be stored in the storage unit 19. Moreover, a map showing the correspondence between the first pixels PIX1 and second pixel PIX2 may be produced in advance, and may be stored in the storage unit 19. In this case, the video-luminance determining unit 182 may obtain the luminance threshold and map from the storage unit 19. Further, gradation luminance characteristics (e.g., the table shown in FIG. 8) for the second pixels PIX2 may be stored in the storage unit 19.

The video-luminance determining unit 182 specifies each first pixel PIX1 corresponding to the second pixel PIX2 on the basis of the map. Moreover, the video-luminance determining unit 182 obtains the luminance of each pixel within the video data. When the luminance of a certain pixel in the video data is equal to or larger than the luminance threshold, the video-luminance determining unit 182 specifies the pixel's position and labels the pixel with f=1. On the other hand, when the luminance of a certain pixel in the video data is smaller than the luminance threshold, the video-luminance determining unit 182 specifies the pixel's position and labels the pixel with f=0.

The luminance setting unit 183 sets the luminance of each first pixel PIX1 and the luminance of each second pixel PIX2 in response to the determination result produced by the video-luminance determining unit 182. To be specific, the luminance setting unit 183 sets the luminance of each first pixel PIX1 and the luminance of each second pixel PIX2 in such a manner that pixels labeled with f=1 in the video data are displayed by the first pixels PIX1, and that pixels labeled with f=0 in the video data are displayed by the second pixels PIX2.

For instance, the luminance setting unit 183 sets the luminance of the first pixel PIX1 positioned in correspondence with a pixel labeled with f=1 in the video data, at the pixel's luminance in the video data. In addition, the luminance setting unit 183 sets the luminance of the first pixel PIX1 positioned in correspondence with a pixel labeled with f=0 in the video data, at zero.

Next, for the first pixel PIX1 included in a plurality of first pixels PIX1 corresponding to a certain second pixel PIX2, and positioned in correspondence with a pixel labeled with f=0 in the video data, the luminance setting unit 183 calculates the sum of the luminance levels (total luminance) of the video data corresponding to such first pixels PIX1. Then, the luminance setting unit 183 sets the luminance of this second pixel PIX2 on the basis of the total luminance and the gradation luminance characteristics of the second pixel PIX2 obtained from the storage unit 19.

In one example, the luminance setting unit 183 may set the luminance of each of the first pixels PIX1 and second pixels PIX2 on the basis of foregoing Equations (3) and (4). The storage unit 19 in this case may store the values γ and α in advance. The luminance setting unit 183 may obtain the values γ and α from the storage unit 19. In another example, the storage unit 19 may store a lookup table that is predetermined on the basis of foregoing Equations (3) and (4). The luminance setting unit 183 in this case may obtain the lookup table from the storage unit 19, and set the luminance of each of the first pixels PIX1 and second pixels PIX2 on the basis of the lookup table.

The display controlling unit 184 generates a driving signal for driving the light-emitting unit 11 (to be more specific, each self-luminous element SE in the light-emitting unit 11) on the basis of the luminance of each of the first pixels PIX1 and second pixels PIX2 set by the luminance setting unit 183. The display controlling unit 184 supplies the driving signal to the light-emitting unit 11. This enables the display unit 10 to perform video display by using both of the first pixels PIX1 and second pixels PIX2.

As described above, the display unit 10 according to the first embodiment is configured such that four first pixels PIX1 correspond to a single second pixel PIX2. This degrades resolution when some of the pixels in video data are displayed by the second pixels PIX2. To be more specific, in the foregoing processing, some of the video data pixels whose luminance is smaller than a luminance threshold undergo luminance-averaging to be displayed by the second pixels PIX2. However, this is not a serious problem in view of human visual properties.

Reference is first made to human contrast sensitivity among the human visual properties. Contrast sensitivity is, simply put, a property that human eyes can recognize a finer pattern when the contrast (luminance ratio) of adjacent displays is large, but cannot recognize a finer pattern when the contrast is small. Reference is made to an instance where all pixels in a certain region within video data has a smaller luminance than a luminance threshold and are displayed by the second pixels PIX2. In this case, the contrast that smaller gradation levels than the luminance threshold value can take is small, thus providing low human contrast sensitivity. For this reason, even a reduced resolution causes no problem.

Reference is next made to human eye's light adaptation among the human visual properties. Light adaptation is a property that the eyes adapt to the brightness of the surroundings, making it impossible to distinguish dark regions that are far from the surroundings. Reference is made to an instance where the gradation levels of video data pixels corresponding one-to-one to four first pixels PIX1 corresponding to a single second pixel PIX2 are 64, 32, 8, and 4. The pixels of the gradation levels 64 and 32 are displayed individually by the first pixels PIX1 when the luminance threshold in the foregoing processing corresponds to the gradation level 16. On the other hand, the pixels of the gradation levels 8 and 4 are averaged and displayed by the second pixels PIX2. The eyes of a human viewing these displays adapt to a bright pixel, which is herein the gradation level 64, and the human cannot visually recognize the pixels of the gradation levels 8 and 4 even when they are averaged and displayed by the second pixels PIX2. For this reason, even a reduced resolution causes no problem.

### Setting of Each Parameter Using Input Unit 17

The input unit 17 may be used as a user interface for allowing the user to set individual parameters for video display. For instance, the input unit 17 may receive a user's input operation to obtain a new luminance threshold. The input unit 17 may then supply the new luminance threshold to the control unit 18. Further, for instance, the input unit 17 may receive a user's input operation to obtain a new gradation luminance characteristic for the second pixels PIX2. The input unit 17 may then supply the new gradation luminance characteristic to the control unit 18. Allowing the user to set the individual parameters via the input unit 17 in this manner enables the display unit 10 to perform video display suited for the user's preferences.

### Second Embodiment

Various examples positional relationships between individual pixels in a display device 2 according to a second embodiment will be described with reference to FIGS. 10 to 12. In the Description, the display unit of the display device 2 will be referred to as a display unit 20. FIG. 10 is a schematic plan view of the display device 2, with illustration of an example positional relationship between its individual pixels. As illustrated in FIG. 10, in plan view, a single second pixel PIX2 may correspond to two first pixels PIX1 positioned in the X-direction.

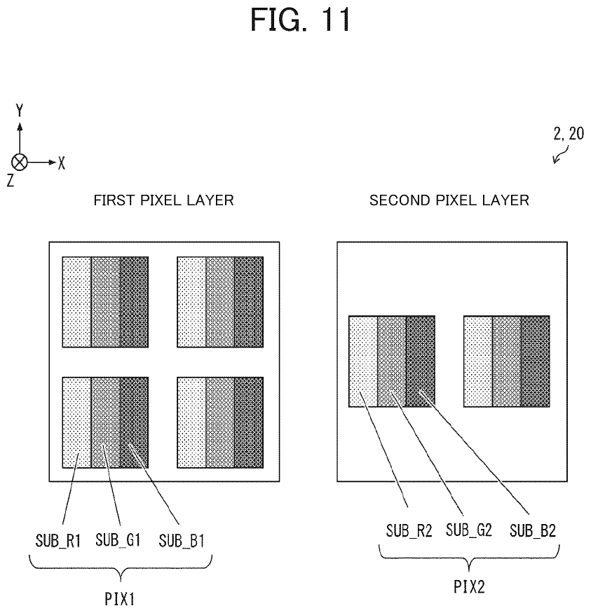

FIG. 11 is a schematic plan view of the display device 2, with illustration of another example positional relationship between its individual pixels. As illustrated in FIG. 11, in plan view, a single second pixel PIX2 may correspond to two first pixels PIX1 positioned in the Y-direction.

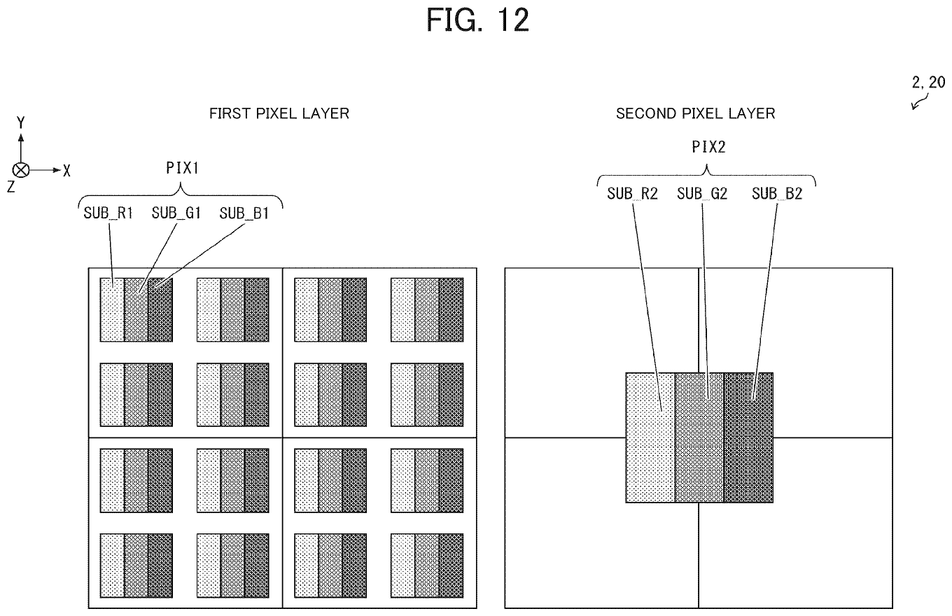

FIG. 12 is a schematic plan view of the display device 2, with illustration of further another example positional relationship between its individual pixels. FIG. 12 illustrates an example where in plan view, a single second pixel PIX2 corresponds to a single first-pixel group including 16 first pixels PIX1. In the single first-pixel group in the example in FIG. 12, (i) four first pixels PIX1 are positioned per line in the X-direction, and (ii) four first pixels PIX1 are positioned per line in the Y-direction.

As described above, each pixel may be laid out in any manner to place a single second pixel PIX2 in correspondence with a plurality of first pixels PIX1 in plan view. A designer of the display device according to one aspect of the present disclosure may select a layout suitable for the specifications of the display device.

The area of a single second pixel PIX2 in plan view may be equal to the area of a single first pixel PIX1, as illustrated in FIGS. 10 and 11. However, the area of a single second pixel PIX2 may be larger than the area of a single first pixel PIX1, as illustrated in FIG. 12. Alternatively, the area of a single second pixel PIX2 may be smaller than the area of a single first pixel PIX1.

As described, in one aspect of the present disclosure, the area of a single second pixel PIX2 in plan view may or may not be equal to the area of a single first pixel PIX1. The designer of the display device may appropriately set the area ratio of a single second pixel PIX2 to a single first pixel PIX1 in plan view (for convenience, referred to as area ratio).

### Supplement to Correspondence Between Individual Pixels

The foregoing examples have described, by way of example, an instance where a single second pixel PIX2 corresponds to a plurality of first pixels PIX1 in plan view. However, as will be apparent to those skilled in the art, a single second pixel PIX2 may be positioned so as to correspond to a single first pixel PIX1 in plan view.

As described above, in the display device according to one aspect of the present disclosure, the number of first pixels PIX1 that correspond to a single second pixel PIX2 (for convenience, referred to as number ratio) may be set at one or more. The designer of the display device may appropriately set the number ratio.

### Numeral Range of Second Dimming Ratio

As described in the first embodiment, the second dimming ratio may be larger than the first dimming ratio. However, the second dimming ratio is set at less than 100% in order for the second pixels PIX2 to implement display in a low-luminance region. In fact, the upper limit of the second dimming ratio in the display device is expected to be about 99.8% due to industrial restrictions in the process of producing the dimming layer.

For instance, the second dimming ratio according to one aspect of the present disclosure stands desirably at 90% or more and less than 100%, more desirably at 95% or more and less than 100%, and still more desirably at 99% or more and less than 100%. The following describes the basis for these numerical ranges.

The emission efficiency of the self-luminous element SE typically tends to lower along with decrease in the area of the self-luminous element SE. In addition, industrial problems, such as susceptibility to foreign substances during photolithography, occur as the area of the self-luminous element SE decreases. Accordingly, it is not preferable to set the foregoing area ratio excessively small when, for instance, the area of the first pixel PIX1 is predetermined. The lower limit of the area ratio preferably stands at about 0.1 by way of example. From the viewpoint of improving display device performance, the lower limit of the area ratio more desirably stands at about 0.5.

On the other hand, the display stability in the display device can be lowered when the area ratio stands at an excessively large value. It is hence not preferable to set the area ratio excessively large. According to the inventor's study, the area ratio whose upper limit stands at about four promises to maintain the display stability in the display device according to any of the embodiments described in the Description. As such, the area ratio may stand at 0.1 to 4 inclusive for instance. The area ratio more desirably stands at 0.5 to 4 inclusive.

Reference is made to a first example where the foregoing luminance threshold is set at 0.25% of the maximum luminance of the first pixels PIX1. That is, the following describes an instance where the luminance threshold is set at 0.0025. As can be seen from FIG. 8, the low-luminance region in the first example is set as a luminance region corresponding to the gradation level 16 and lower levels of the first pixels PIX1. The first example thus corresponds to the example according to the first embodiment.

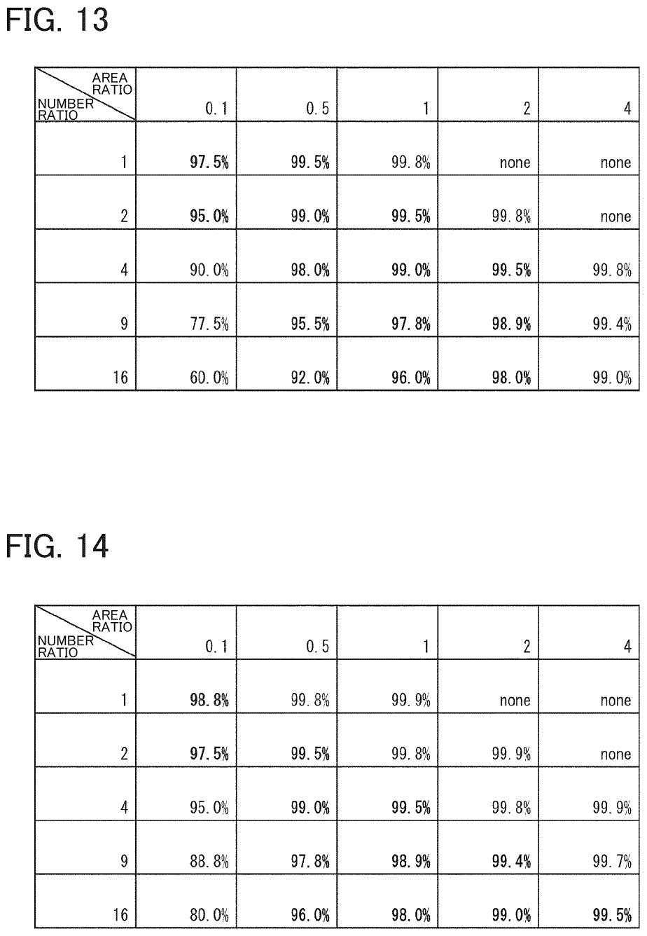

As shown in FIG. 13, the inventor calculated the second dimming ratio necessary for expressing a low-luminance region by the use of the second pixels PIX2, with regard to various combinations of the area ratio and number ratio in the first example. The notation “none” in the example in FIG. 13 indicates combinations in which a low-luminance region cannot be expressed by the second pixels PIX2. The boldface notations in the example in FIG. 13 indicate combinations that are conceivably preferable particularly in practical use. These notations also apply to each corresponding drawing that will be described below.

Reference is made to a second example where the luminance threshold is set at 0.125% of the maximum luminance of the first pixels PIX1. That is, the following describes an instance where the luminance threshold is set at 0.00125. As can be seen from FIG. 8, the low-luminance region in the second example is set as a luminance region corresponding to the gradation level 12 and lower levels of the first pixels PIX1.

As shown in FIG. 14, the inventor calculated the second dimming ratio necessary for expressing a low-luminance region by the use of the second pixels PIX2, with regard to various combinations of the area ratio and number ratio in the second example. As shown in FIG. 14, the second dimming ratio necessary at the same area ratio and number ratio is high in the second example when compared with that in the first example.

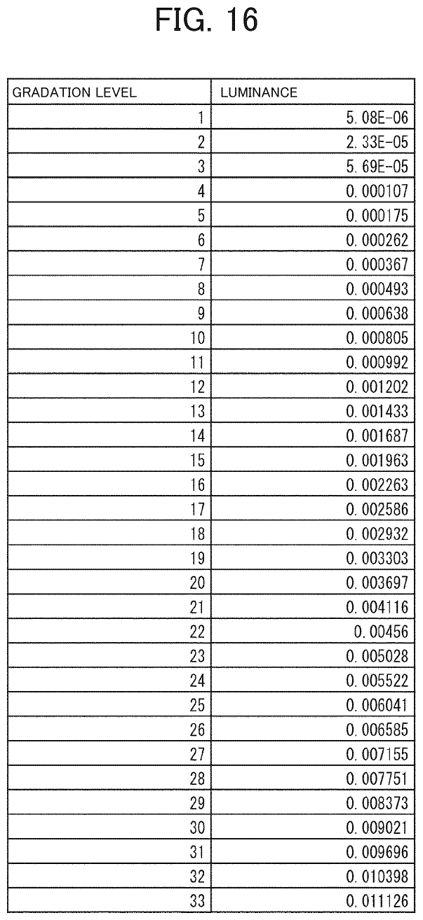

Reference is made to a third example where the luminance threshold is set at 1% of the maximum luminance of the first pixels PIX1. That is, the following describes an instance where the luminance threshold is set at 0.01. As can be seen from FIG. 16, the low-luminance region in the third example is set as a luminance region corresponding to the gradation level 31 and lower levels of the first pixels PIX1. FIG. 16 shows luminance corresponding to each of the gradation levels 1 to 32 of the first pixels PIX1 in a 256-level gradation expression.

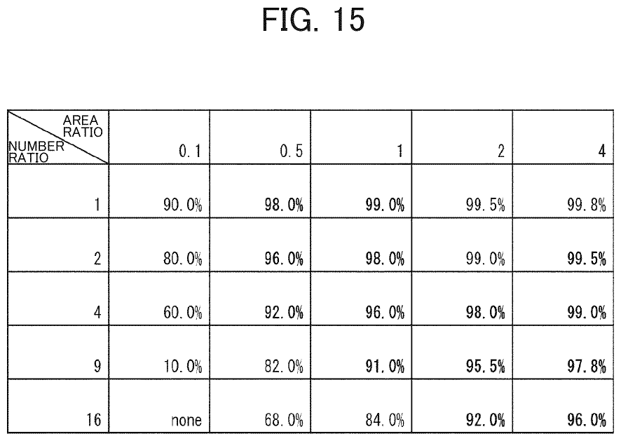

As shown in FIG. 15, the inventor calculated the second dimming ratio necessary for expressing a low-luminance region by the use of the second pixels PIX2, with regard to various combinations of the area ratio and number ratio in the third example. As shown in FIG. 15, the second dimming ratio necessary at the same area ratio and number ratio is low in the third example when compared with that in the first example.

As shown in FIGS. 13 to 15, the second dimming ratio necessary together with increase in the number ratio decreases when the area ratio is constant. In addition, the second dimming ratio necessary together with decrease in the area ratio decreases when the number ratio is constant. The foregoing reveals that it is preferable not to set the second dimming ratio excessively small so that the area ratio and number ratio fall under a practical range.

FIG. 13 reveals that a second dimming ratio of 90% or more can mostly cover combinations that are conceivably preferable particularly in practical use in the first example. Accordingly, the inventor set the second dimming ratio at 90% as a desirable lower limit.

Furthermore, FIGS. 13 to 15 reveal that a second dimming ratio of 95% or more can mostly cover combinations that are conceivably preferable particularly in practical use in the first to third examples. Accordingly, the inventor set the second dimming ratio at 95% as a more desirable lower limit. In addition, a second dimming ratio of 99% or more can cover all combinations that are conceivably preferable particularly in practical use in the first to third examples. Accordingly, the inventor set the second dimming ratio at 99% as a still more desirable lower limit.

### Numeral Range of Luminance Threshold

As can be understood from the foregoing individual descriptions related to FIGS. 13 to 15, the necessary second dimming ratio decreases along with increase in the luminance threshold. It can be thus difficult to express a low-luminance region by the use of the second pixels PIX2 as the luminance threshold increases. It is hence preferable that, for instance, the luminance threshold do not exceed 5% of the maximum luminance of the first pixels PIX1.

Furthermore, as can be understood from the foregoing individual descriptions, setting the luminance threshold at 0.1 to 1% inclusive of the maximum luminance of the first pixels PIX1 facilitates adopting a combination of the area ratio and number ratio that is conceivably preferable in practical use, and adopting a suitable second dimming ratio.

Accordingly, in one aspect of the present disclosure, it is desirable that the luminance threshold be set at 0.1 to 5% inclusive of the maximum luminance of the first pixels PIX1, and it is more desirable that the luminance threshold be set at 0.1 to 1% inclusive of the maximum luminance of the first pixels PIX1.

### Supplement to The Case of Number Ratio Standing at 1

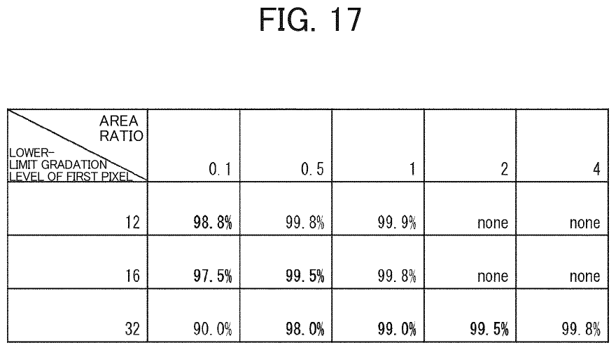

As shown in FIG. 17, for various combinations of the area ratio and the lower limit of the gradation level at which the first pixels PIX1 are driven (for convenience, referred to as the lower-limit gradation level of the first pixels) in the case of a number ratio standing at 1, the inventor calculated the second dimming ratio necessary for expressing a low-luminance region by the use of the second pixels PIX2. As can be seen from FIG. 17, a number ratio standing at 1 also enables adopting an area ratio that is conceivably preferable in practical use, and adopting a suitable second dimming ratio.

The number of first pixels PIX1 corresponding to the second pixel PIX2 is smaller at a number ratio standing at 1 than that at a number ratio greater than 1. As such, the luminance that the second pixel PIX2 should output is lower at a number ratio standing at 1 than that at a number ratio greater than 1. It is accordingly preferable to set the second dimming ratio larger. Alternatively, it is preferable to make the area of the second pixel PIX2 smaller (that is, to make the area ratio larger). To be specific, it is preferable to adopt combinations of the lower-limit gradation level and area ratio corresponding to the boldface numeric values in FIG. 17. Further, a combination may be adopted that can achieve the intermediate value of these boldface numeric values.

At a number ratio standing at 1, the display resolution in the second pixel layer is equal to the display resolution in the first pixel layer. In other words, the same display resolution as that in a non-low-gradation region is maintained in a low-gradation region as well. As such, a display device having a number ratio standing at 1 is suitable for applications that require a high display resolution in a non-low-gradation region (e.g., medical-image analysis or artwork authentication).

### Third Embodiment

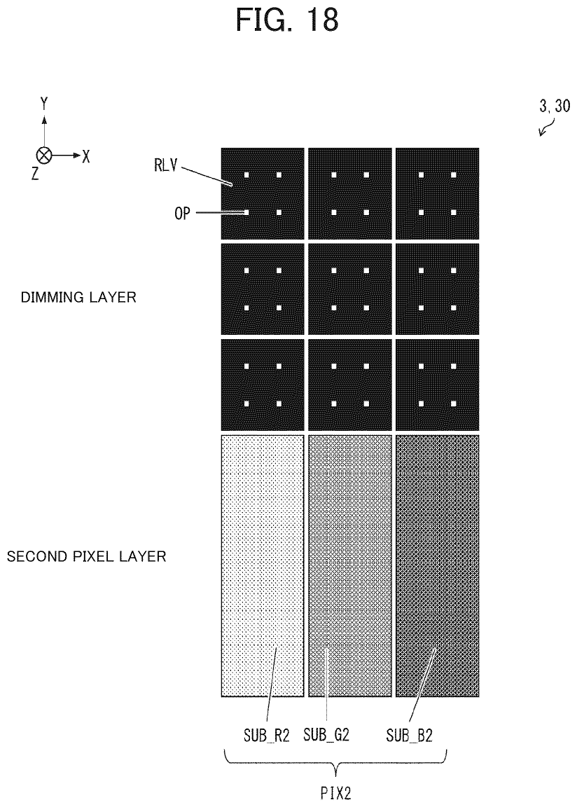

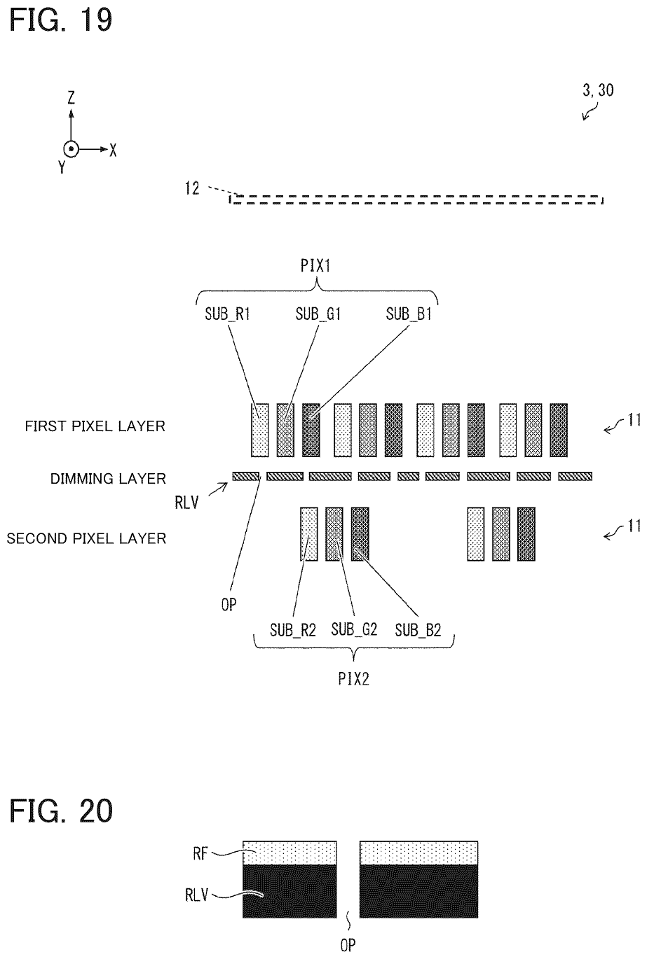

The configuration of a display device 3 according to a third embodiment will be described with reference to FIGS. 18 and 19. In the Description, the display unit of the display device 3 will be referred to as a display unit 30. Moreover, the dimming units of the display unit 30 will be referred to as dimming units RLV FIG. 18 is a schematic plan view of an example configuration of the dimming units RLV FIG. 19 is a schematic front view of this example configuration.

In one example, the dimming units RLV may be light-absorptive units that absorb a part of light exited from the second pixels PIX2. Thus, the dimming units RLV as light-absorptive units may contain a light-absorptive material that absorbs this light.

The light-absorptive material may have a light-absorptive property of absorbing light in the whole wavelength range of the visible-light band. An example of the light-absorptive material is carbon black. Thus, for example, a blackbody can be used as the light-absorptive units.

Alternatively, the light-absorptive material may have a light-absorptive property of absorbing only light in a predetermined wavelength range of the visible-light band. Examples of the light-absorptive material include dyes and pigments. Thus, for example, a color filter can be used as the light-absorptive units.

In another example, the dimming units RLV may be light-reflective units that reflect a part of light exited from the second pixels PIX2. Thus, the dimming units RLV as light-reflective units can be formed by the use of metal.

As illustrated in FIGS. 18 and 19, the dimming units RLV (light-absorptive units or light-reflective units) may include a plurality of openings OP. The openings OP may be formed through any patterning. The light exited from the second pixels PIX2 passes through the openings OP and travels to the display surface 12. Thus, varying at least one of the number of openings OP and their area can change the second dimming ratio.

To prevent spatial luminance imbalance that is visually recognized by the user, the openings OP are preferably distributed uniformly in the dimming units RLV Thus, the openings OP are preferably formed such that a plurality of openings OP correspond to a single second pixel PIX2. By way of example, the number of openings OP corresponding to a single second pixel PIX2 may be four or more, desirably eight or more, more desirably ten or more.

By the way, a part of the light exited from the first pixels PIX1 travels down the first pixels PIX1. The dimming units RLV as light-reflective units can reflect the light to cause the reflected light to travel to the display surface 12. As such, more of the light exited from the first pixels PIX1 can be used for screen display. This can improve the efficiency of light use in the display device 3.

### Modifications

Modifications related to the dimming units of the display device 3 will be described with reference to FIGS. 20 to 23. FIG. 20 is a front view of a first modification of the dimming units. As illustrated in FIG. 20, the display device 3 may include additional light-reflective units (additional light-reflective units) RF positioned over (e.g., on the upper surface of) the dimming units RLV

The additional light-reflective units RF may be designed so as to reflect a part of light exited from the first pixels PIX1. For instance, the additional light-reflective units RF may reflect a part of light exited from the first pixels PIX1 and traveling downward. The additional light-reflective units RF may have a light reflectivity of 90% by way of example. In other words, the additional light-reflective units RF may have a light transmittance of 10%. The additional light-reflective units RF are provided so as not to cover the openings OP. As described above, the additional light-reflective units RF may be provided so as to correspond to effective areas of the dimming units RLV (i.e., areas other than the openings OP in the dimming units RL). The additional light-reflective units RF can improve the efficiency of light use in the display device 3 irrespective of the kind of the dimming units RLV (e.g., even when the dimming units RLV are light-absorptive units).

Reference is made to an instance where the light exited from the first pixels PIX1 travels upward and downward 50% each. The first modification enables the additional light-reflective units RF to reflect, for use in display, 90% of the light exited from the first pixels PIX1 and traveling downward. That is, the first modification enables about 45% (=50%×90%) of the light exited from the first pixels PIX1 and traveling downward, to be used in display. As such, the first modification improves the efficiency of light use in the display device 3 from 50% to 95%.

It is little necessary to consider that light exited from the first pixels PIX1, passed through the openings OP and then passed downward reflects again to affect display. For one reason, this light has a few components that reflect exactly vertically. For another reason, there is no need to provide a reflective layer under the second pixels PIX2 because it is not necessary to pursue the efficiency of light use in the second pixels PIX2. As such, it can be said that the light exited from the first pixels PIX1, passed through the openings OP and then passed downward has a few components that reflect again.

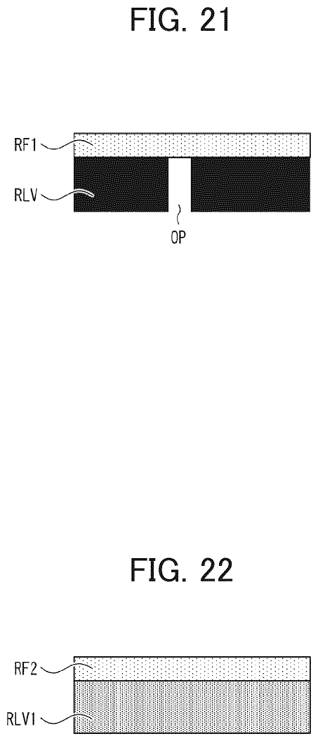

FIG. 21 is a front view of a second modification of the dimming units. The additional light-reflective unit in FIG. 21 will be referred to as an additional light-reflective unit RF1. The additional light-reflective units RF are provided so as to cover the openings OP. The additional light-reflective unit RF1 thus covers the entire upper surface of the dimming unit RLV

The second modification enables using the additional light-reflective units RF1 having a lower reflectivity than the additional light-reflective units RF according to the first modification. The additional light-reflective units RF1 may have a light reflectivity of 50% by way of example. The second modification enables about 25% (=50%×50%) of the light exited from the first pixels PIX1 and traveling downward, to be used in display. As such, the second modification improves the efficiency of light use in the display device 3 from 50% to 75%. The increase in the efficiency of light use in the second modification is smaller than that in the first modification. However, the additional light-reflective units RF1 according to the second modification have a high transmittance to a certain extent and can be thus provided so as to cover the openings OP. The second modification thus facilitates processing the dimming units RLV when compared with the first modification.

Further, the additional light-reflective units RF1 according to the second modification also dim light exited from the second pixels PIX2, passing through the openings OP and traveling upward. The second modification thus enables enlarging the openings OP when compared with the first modification. Higher accuracy is not required for the area control of the openings OP as the total area of the openings OP increases; this facilitates processing the dimming units RLV In addition, the distribution of the openings OP becomes easier to adjust as the total area of the openings OP increases. As such, the second modification can offer the display device 3 that is industrially easier to manufacture. The second modification furthermore enables the additional light-reflective units RF1 to be formed using a more inexpensive light-reflective material having a low reflectivity.

As apparent from the above description about the first and second modifications, the designer of the display device according to one aspect of the present disclosure may select the capability of the additional light-reflective units in view of both improvement in the efficiency of light use in the display device and the industrial productivity of the display device. Furthermore, additional light-reflective units can be used whose capability is intermediate between the additional light-reflective units RF according to the first modification and the additional light-reflective units RF1 according to the second modification.

FIG. 22 is a front view of a third modification of the dimming units. As illustrated in FIG. 22, the dimming unit according to the third modification will be referred to as a dimming unit RLV1. Unlike the dimming units RLV in the above-described examples, the dimming units RLV1 include no openings OP. The following describes an instance where the dimming units RLV are light-absorptive units.

The display device 3 may include additional light-reflective units RF2 positioned over the dimming units RLV1. The additional light-reflective unit RF2 covers the entire upper surface of the dimming unit RLV1. The optical property of the additional light-reflective units RF2 may be set in accordance with the optical property of the dimming units RLV1. For instance, the reflectivity of light of the additional light-reflective units RF2 may be set low when the dimming units RLV1 have a high light-absorption capability. On the other hand, the reflectivity of light of the additional light-reflective units RF2 may be set high when the dimming units RLV1 do not have a so high light-absorption capability. The additional light-reflective units RF2 according to the third modification can improve the efficiency of light use in the display device 3.

Unlike those in the second modification, the dimming units according to the third modification include no openings OP. This further facilitates forming the additional light-reflective units. Further, in the third modification, providing the additional light-reflective units RF2 enables the display device 3 to be produced using light-absorptive units that do not necessarily have a high light-absorption capability. Hence, for instance, the concentration of the light-absorptive material (e.g., dyes or pigments) of the light-absorptive units can be reduced. This can improve the film formation capability of the light-absorptive units.

Further, in the third modification, the combination of the light-absorptive unit and additional light-reflective unit enables adjusting the spectrum property of light exited from the second pixels PIX2 and traveling to the display surface 12. The third modification can thus improve, for instance, the flexibility in designing white balance as well.

### Fourth Embodiment

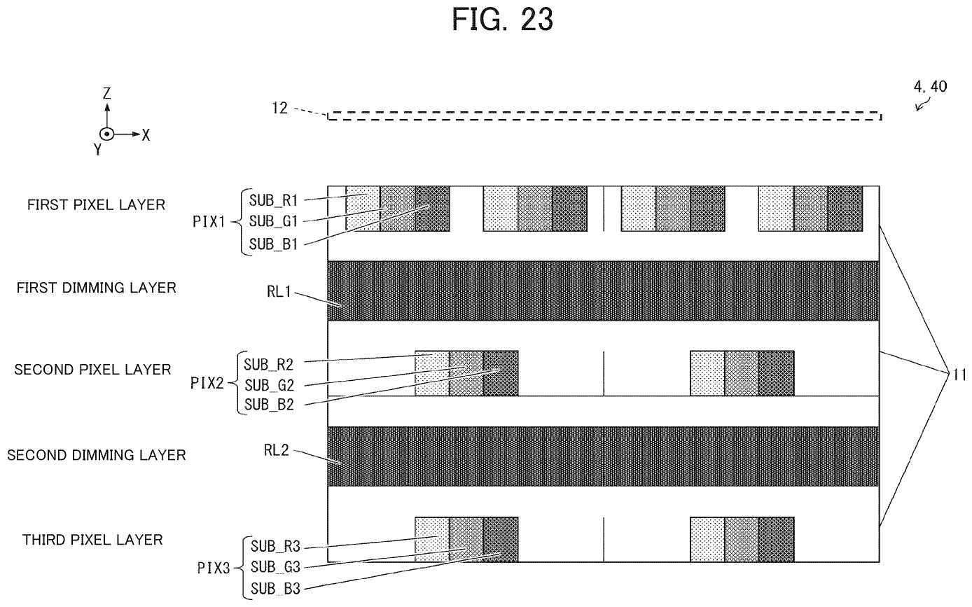

FIG. 23 is a schematic front view of the configuration of a display device 4 according to a fourth embodiment. In the Description, the display unit of the display device 4 will be referred to as a display unit 40. The display unit 40 further includes third pixels PIX3 each including one or more subpixels. In the Description, a subpixel constituting the third pixel PIX3 will be referred to as as a third subpixel.

As illustrated in FIG. 23, a single third pixel PIX3 may include a single red third subpixel SUB_R3, a single green third subpixel SUB_G3, and a single blue third subpixel SUB_B3. A single third pixel PIX3 may be positioned so as to correspond to one or more second pixels PIX2 in plan view. FIG. 23 illustrates an example where a single third pixel PIX3 corresponds to a single second pixel PIX2.

The second pixels PIX2 in the example in FIG. 23 are positioned above the third pixels PIX3. In other words, the third pixels PIX3 are positioned below the second pixels PIX2. Thus, the display unit 40 is structured such that a third pixel layer (a pixel layer including the third pixels PIX3), the second pixel layer, and the first pixel layer are positioned in the stated order from bottom to top. In the example in FIG. 23, a single second pixel PIX2 is positioned so as to overlap a single third pixel PIX3 in plan view.

The display unit 40 includes a first dimming unit RL1 as a dimming unit that can prevent a part of light exited from the second pixels PIX2 from passing upward. A first dimming layer (a dimming layer including the first dimming unit RL1) is positioned over the second pixel layer and under the first pixel layer. Moreover, the display unit 40 further includes a second dimming unit RL2 as a dimming unit that can prevent a part of light exited from the third pixels PIX3 from passing upward.

A second dimming layer (a dimming layer including the second dimming unit RL2) is positioned over the third pixel layer and under the second pixel layer. As described above, the second dimming unit RL2 is positioned below the first dimming unit RL1. The second dimming unit RL2 may or may not have the same optical property as the first dimming unit RL1.

In the Description, outgoing light from the third pixels PIX3 emitting light at the maximum luminance will be referred to as third light. Moreover, the intensity of the third light exited from the third pixels PIX3 will be denoted as I3. In addition, the intensity of the third light exited outside from the display surface 12 will be denoted as I3′. Furthermore, the difference between 13 and I3′ will be denoted as ΔI3. Here, ΔI3=I3−I3′ is established.

The dimming ratio (third dimming ratio) of the third pixels PIX3 can be defined in a manner similar to those in the first and second dimming ratios described in the first embodiment. To be specific, the third dimming ratio (for convenience, referred to as Ratio3) is defined as the ratio of ΔI3 to I3. That is, Ratio3 is expressed as

$$Ratio 3 = Δ I 3 / I 3 = ( I 3 - I 3 ’ ) / I 3. \qquad ( 5 )$$

As seen from FIG. 23, the light exited from the third pixels PIX3 passes through the second dimming unit RL2 and the first dimming unit RL1 in the stated order and travels to the display surface 12. As such, in the display unit 40, the third dimming ratio is larger than the second dimming ratio.

Upon the luminance of the first pixels PIX1 falling below a first luminance threshold, the control unit 18 in the display device 4 may turn off the first pixels PIX1 and turn on the second pixels PIX2; here the first pixels PIX1 correspond to the second pixels PIX2. Moreover, upon the post-dimming luminance of the second pixels PIX2 falling below a second luminance threshold, the control unit 18 may turn off the second pixels PIX2 and turn on the third pixels PIX3; here the second pixels PIX2 correspond to the third pixels PIX3. The second luminance threshold may be set smaller than the first luminance threshold.

Reference is made to an example where the first dimming unit RL1 and the second dimming unit RL2 both have a light-blocking ratio of 90%. In this case, the second pixels PIX2 have a dimming ratio of 90%, and the third pixels PIX3 have a dimming ratio of 99%. In this case, for instance, the first luminance threshold can be set at 0.025 (i.e., 2.5% of the maximum luminance of the first pixels PIX1), and the second luminance threshold can be set at 0.0025 (i.e., 0.25% of the maximum luminance of the first pixels PIX1). Although the effect of gradation expression is equivalent to that in the first embodiment, this example enables control in a wider low-gradation region than the first embodiment.

Reference is made to another example where the first dimming unit RL1 has a light-blocking ratio of 99%, and the second dimming unit RL2 has a light-blocking ratio of 90%. In this case, the second pixels PIX2 have a dimming ratio of 99%, and the third pixels PIX3 have a dimming ratio of 99.9%. In this case, for instance, the first luminance threshold can be set at 0.0025, and the second luminance threshold can be set at 0.00025 (i.e., 0.025% of the maximum luminance of the first pixels PIX1). This example is suitable for more accurate low-gradation expressions. For instance, an accurate low-gradation display can be achieved in a 1024-level gradation expression.

The display device 4 can turn on only the third pixels PIX3 in a luminance region of less than the second luminance threshold. The display device 4 can thus further improve display performance in a low-luminance region. The display device 4 is suitable for applications that require high contrast (e.g., high-end monitors).

### Fifth Embodiment

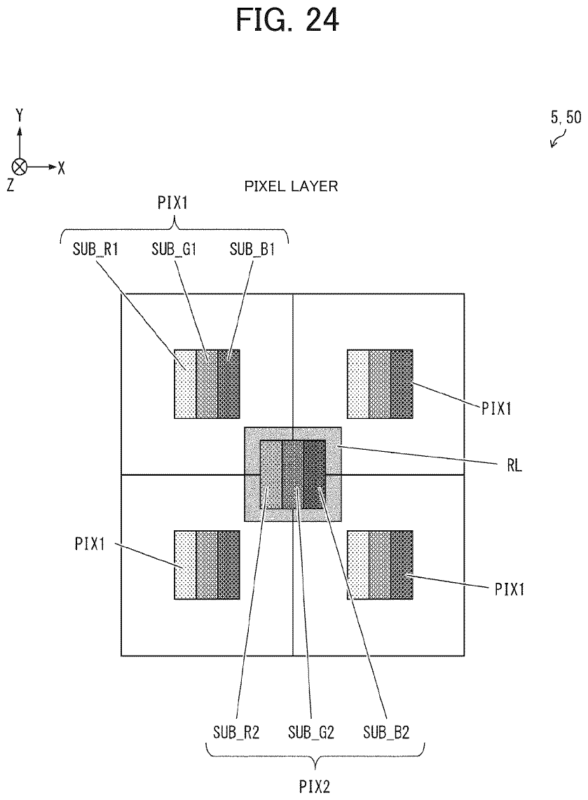

FIG. 24 is a schematic plan view of the configuration of a display device 5 according to a fifth embodiment. In the Description, the display unit of the display device 5 will be referred to as a display unit 50. Unlike the display units 10 to 40, the display unit 50 includes the first pixels PIX1 and second pixels PIX2 positioned on an identical layer. That is, the display unit 50 includes a common pixel layer including the first pixels PIX1 and second pixels PIX2.

In the fifth embodiment as well, a single second pixel PIX2 may be positioned so as to correspond to one or more first pixels PIX1 in plan view. FIG. 24 illustrates an example where a single second pixel PIX2 corresponds to a single first-pixel group including four first pixels PIX1. In the single first-pixel group in the example in FIG. 24, (i) two first pixels PIX1 are positioned per line in the X-direction, and (ii) two first pixels PIX1 are positioned per line in the Y-direction. As illustrated in FIG. 24, the second pixel PIX2 may be positioned at the center of the four first pixels PIX1 constituting the first-pixel group.

The dimming layer according to the fifth embodiment is positioned over the common pixel layer. As illustrated in FIG. 24, thee dimming units RL according to the fifth embodiment may be positioned so as not to cover the first pixels PIX1 and to cover the second pixels PIX2. Thus, the position of a single dimming unit RL according to the fifth embodiment corresponds to a single second pixel PIX2 in plan view. As such, the display unit 50 can include a plurality of first pixels PIX1 positioned so as to surround a single dimming unit RL in plan view.

The fifth embodiment can reduce the total number of layers of the display unit when compared with the first to fourth embodiments. Hence, the size (in particular, the dimension in the height direction) and weight of the display device can be reduced. The configuration of the display device 5 is thus suitable for applications that require downsizing and weight reduction (e.g., mobile devices).

### Modification

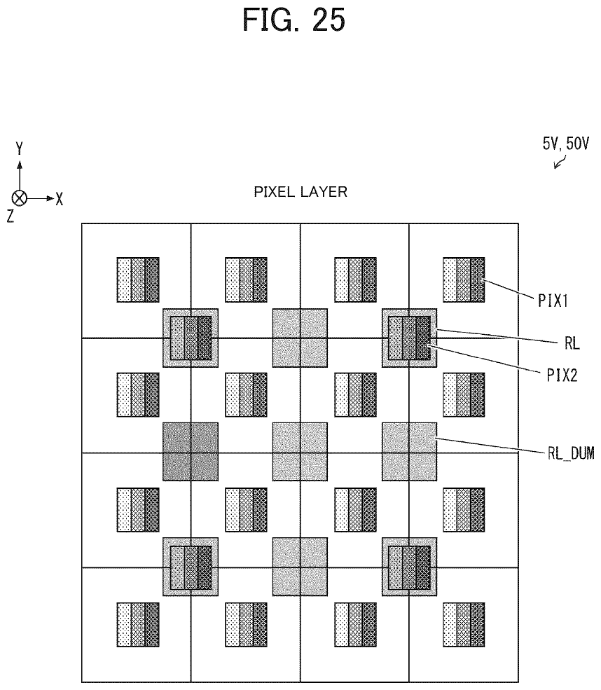

FIG. 25 is a schematic plan view of the configuration in a modification of the display device 5 (for convenience, referred to as a display device 5V). In the Description, the display unit of the display device 5V will be referred to as a display unit 50V The display unit 50V may further include dummy dimming units RL_DUM having a shape identical to that of the dimming units RL.

The dummy dimming units RL_DUM may have an optical property equivalent to that of the dimming units RL. The dummy dimming units RL_DUM may be positioned on the dimming layer, or on a dummy dimming layer different from the dimming layer. However, from the viewpoint of display device downsizing, the dummy dimming units RL_DUM are preferably positioned on the dimming layer. That is, the dimming units RL and the dummy dimming units RL_DUM are preferably positioned on an identical layer.

The dummy dimming units RL_DUM may be positioned so as not to cover both of the first pixels PIX1 and second pixels PIX2. By way of example, the dummy dimming units RL_DUM may be positioned such that the dimming units RL and the dummy dimming units RL_DUM form a predetermined pattern in plan view. As such, the display unit 50 can include a plurality of first pixels PIX1 positioned so as to surround a single dummy dimming unit RL_DUM in plan view.

In the example in FIG. 25, a single dummy dimming unit RL_DUM is positioned between two dimming units RL adjacent to each other in the X-direction. Moreover, a single dummy dimming unit RL_DUM is positioned between two dimming units RL adjacent to each other in the Y-direction. Furthermore, four dimming units RL are positioned at the respective four vertexes of a single virtual quadrangle. A single dummy dimming unit RL_DUM is positioned at the center of the single virtual quadrangle.

As described above, the display unit 5 includes the common pixel layer including the first pixels PIX1 and second pixels PIX2, and includes the dimming units RL covering only the second pixels PIX2. Accordingly, the dimming units RL in the display device 5 are visually recognized by the user more easily than those in the display devices 1 to 4. For instance, the dimming units RL can be visually recognized as a black-dot pattern in an image during the light emission of the first pixels PIX1.

Accordingly, the display device 5V further includes dummy dimming units RL_DUM. Typically, according to the human visual properties, a certain pattern is less likely to be recognized visually along with increase in the spatial frequency of the pattern. Further providing the dummy dimming units RL_DUM can increase the spatial frequency of a black-dot pattern. As such, the display device 5V can make the black-point pattern unobtrusive to the user.

### Supplement

(1) The foregoing embodiments have described, by way of example, an instance where the display units are each a multicolor panel (e.g., an RGB panel). However, the display unit according to one aspect of the present disclosure may be a monochrome panel. Thus, each of the first to third pixels may be a monochrome pixel. Accordingly, the first and second pixels according to one aspect of the present disclosure may include a single first subpixel and a single second subpixel, respectively.

Reference is made to an instance where the display unit is a blue panel. In this case, a single first pixel PIX1 may include a single blue first subpixel SUB_B1, and a single second pixel PIX2 may include a single blue second subpixel SUB_B2. The above description about the first and second pixels applies to the third pixels as well.

(2) As can be understood from the foregoing embodiments, the first pixels play a more important role for image representation than the second pixels. Accordingly, the first pixels may be referred to as picture elements.

### Example Implementation by Software

The functions of the display devices 1 to 5V (hereinafter, referred to as devices) can be each implemented by a program for causing a computer to function as the devices, and for causing the computer to function as each control block (in particular, each unit included in the control unit 18) of the devices.

The devices in this case each include, as hardware for executing the program, a computer having at least one controller (e.g., a processor) and at least one storage (e.g., a memory). Executing the program by the use of these controller and storage can implement the individual functions described in the foregoing embodiments.

The program may be recorded in one or more non-transitory computer-readable recording media. These recording media may or may not be included in the foregoing devices. In the latter case, the program may be provided to the device via any wired or wireless transmission medium.

Further, the function of each control block can be implemented, in whole or in part, by a logic circuit. For instance, an integrated circuit including a logic circuit that functions as each control block is also encompassed in one aspect of the present disclosure. Other than the foregoing, the function of each control block can be also implemented by, for instance, a quantum computer.

Further, the individual processing described in the above embodiments may be executed by artificial intelligence (AI). AI in this case may be operated by the foregoing controller or by another device (e.g., an edge computer or a cloud server).

### Additional Note

One aspect of the present disclosure is not limited to the foregoing embodiments. Various modifications can be made within the scope of the claims. An embodiment that is obtained in combination as appropriate with the technical means disclosed in the respective embodiments is also encompassed within the technical scope of one aspect of the present disclosure. Furthermore, combining the technical means disclosed in the respective embodiments can form a new technical feature.

1. A self-luminous display device comprising:
a display surface;
first pixels each including one or more first subpixels;
second pixels each including one or more second subpixels; and
dimming units configured to prevent a part of light exited from the second pixels from passing through the display surface,
wherein in a plan view from a direction of a normal to the display surface, one of the second pixels is positioned so as to correspond to one or more of the first pixels,
outgoing light from the first pixels emitting light at a maximum luminance is first light,
outgoing light from the second pixels emitting light at a maximum luminance is second light,
a ratio of difference between an intensity of the first light exited from the first pixels and an intensity of the first light exited outside from the display surface, to the intensity of the first light exited from the first pixels is a first dimming ratio,
a ratio of difference between an intensity of the second light exited from the second pixels and an intensity of the second light exited outside from the display surface, to the intensity of the second light exited from the second pixels is a second dimming ratio, and
the second dimming ratio is larger than the first dimming ratio.

2. The self-luminous display device according to claim 1, wherein the first pixels are positioned closer to the display surface than the second pixels.

3. The self-luminous display device according to claim 2, further comprising third pixels each including one or more third subpixels,
wherein in the plan view, one of the third pixels is positioned so as to correspond to one or more of the second pixels,
the second pixels are positioned closer to the display surface than the third pixels,
the self-luminous display device further comprises a second dimming unit configured to prevent a part of light exited from the third pixels from passing through the display surface,
outgoing light from the third pixels emitting light at a maximum luminance is third light,
a ratio of difference between an intensity of the third light exited from the third pixels and an intensity of the third light exited outside from the display surface, to the intensity of the third light exited from the third pixels is a third dimming ratio, and
the third dimming ratio is larger than the second dimming ratio.

4. The self-luminous display device according to claim 1, wherein the first pixels and the second pixels are positioned on an identical layer.

5. The self-luminous display device according to claim 4, further comprising dummy dimming units each having a shape identical to that of the dimming units,
wherein in the plan view,
a plurality of the first pixels is positioned so as to surround one of the dimming units, and
a plurality of the first pixels is positioned so as to surround one of the dummy dimming units.

6. The self-luminous display device according to claim 1, wherein the second dimming ratio stands at 90% or more and less than 100%.

7. The self-luminous display device according to claim 1, wherein the second dimming ratio stands at 95% or more and less than 100%.

8. The self-luminous display device according to claim 1, wherein the second dimming ratio stands at 99% or more and less than 100%.

9. The self-luminous display device according to claim 1, wherein in the plan view, an area ratio of one of the second pixels to one of the first pixels stands at 0.1 to 4 inclusive.

10. The self-luminous display device according to claim 1, wherein in the plan view, an area ratio of one of the second pixels to one of the first pixels stands at 0.5 to 4 inclusive.

11. The self-luminous display device according to claim 1, wherein in the plan view, one of the second pixels is positioned so as to correspond to a plurality of the first pixels.

12. The self-luminous display device according to claim 11, wherein in the plan view, one of the second pixels corresponds to two of the first pixels positioned in a first direction.

13. The self-luminous display device according to claim 11, wherein in the plan view, one of the second pixels corresponds to two of the first pixels positioned in a second direction.

14. The self-luminous display device according to claim 11,
wherein in the plan view, one of the second pixels corresponds to a single first-pixel group including four of the first pixels, and
wherein in the single first-pixel group,
(i) two of the first pixels are positioned per line in a first direction, and
(ii) two of the first pixels are positioned per line in a second direction intersecting with the first direction.

15. The self-luminous display device according to claim 11,
wherein in the plan view, one of the second pixels corresponds to a single first-pixel group including sixteen of the first pixels, and
wherein in the single first-pixel group,
(i) four of the first pixels are positioned per line in a first direction, and
(ii) four of the first pixels are positioned per line in a second direction intersecting with the first direction.

16. The self-luminous display device according to claim 11, wherein in the plan view, one of the second pixels is positioned at a center of the plurality of the first pixels corresponding to the second pixel.

17. (canceled)

18. (canceled)

19. The self-luminous display device according to claim 2, further comprising an additional light-reflective unit positioned closer to the display surface than the dimming units, and configured to reflect a part of light exited from the first pixels.

20. (canceled)

21. (canceled)

22. (canceled)

23. A self-luminous display device comprising:
a display surface;
first pixels each including one or more first subpixels;
second pixels each including one or more second subpixels; and
dimming units configured to prevent a part of light exited from the second pixels from passing through the display surface,
wherein in a plan view from a direction of a normal to the display surface, one of the second pixels is positioned so as to correspond to one or more of the first pixels,
outgoing light from the first pixels emitting light at a maximum luminance is first light,
outgoing light from the second pixels emitting light at a maximum luminance is second light,
a ratio of difference between an intensity of the first light exited from the first pixels and an intensity of the first light exited outside from the display surface, to the intensity of the first light exited from the first pixels is a first dimming ratio,
a ratio of difference between an intensity of the second light exited from the second pixels and an intensity of the second light exited outside from the display surface, to the intensity of the second light exited from the second pixels is a second dimming ratio, and
the second dimming ratio is larger than the first dimming ratio,
the self-luminous display device further comprising a control unit configured to control an emission state of the first pixels and an emission state of the second pixels,
wherein upon a luminance of the first pixels falling below a luminance threshold, the control unit turns off the first pixels and turns on the second pixels, the first pixels corresponding to the second pixels.

24. The self-luminous display device according to claim 23, wherein the luminance threshold is set at 0.1 to 5% inclusive of the maximum luminance of the first pixels.

25. The self-luminous display device according to claim 23, wherein the luminance threshold is set at 0.1 to 1% inclusive of the maximum luminance of the first pixels.
